(19) United States
(12) Patent Application Publication
(10) Pub. No.: US 2016/0238156 A1
(43) Pub. Date: Aug. 18, 2016

(54) PUMP VALVE SEAL WITH ABRASION GAUGE

(71) Applicant: Schlumberger Technology Corporation, Sugar Land, TX (US)

(72) Inventors: Joseph Milton HUBENSCHMIDT, Sugar Land, TX (US); Thomas Joseph REBLER, Richmond, TX (US); Trent LEE, Sugar Land, TX (US)

(21) Appl. No.: 14/622,314

(22) Filed: Feb. 13, 2015

(51) Int. Cl. F16K 37/00; F16K 3/314; F16K 27/04; F16K 3/02

(52) U.S. Cl. CPC F16K 37/0008; F16K 3/0218; F16K 3/314; F16K 27/04

(57) ABSTRACT

A valve element includes a valve body member formed of a rigid material, where the valve body member defines a front-to-rear extending longitudinal axis, and has a generally radially outwardly facing first contact surface of generally frusto-conical configuration tapering forwardly, and a radially inwardly extending annular recess disposed rearwardly of the contact surface. The valve body member further includes a sealing insert mounted on the valve body member which includes a generally radially inwardly projecting lip received in the recess, an axially forwardly facing sealing face, a radially inwardly facing second contact surface disposed between the sealing face and the lip which tightly engages the first contact surface to conform to the frusto-conical configuration thereof, and a seal abrasion gauge disposed upon an outer peripheral portion of the axially forwardly facing sealing face.

### FIELD

This disclosure relates generally to fluid delivery systems and more particularly to valve assemblies delivering particulate-containing fluids.

### BACKGROUND

The statements in this section merely provide background information related to the present disclosure and may not constitute prior art.

It is common to pump fluids that contain particulates into oil and gas wells. For example, fracturing fluids typically contain proppant particles, such as sand, synthetic particles or small beads, with sizes typically from U.S. Standard Sieve sizes 10 through 60. Reciprocating plunger pumps are frequently used to create the high-pressure fluid flow needed to inject fluids, such as fracturing fluids, into oil and gas formations. These pumps typically include valve assemblies that are biased toward the closed position. When the motion of the plunger creates a differential pressure across the valve, the differential pressure forces the valve open, allowing the fluid to flow through the valve. However, solid particles in the fluid can become trapped within the valve assembly upon valve body, allowing extrusion or damage to valve assembly components and reducing the useful life of the valve assembly.

Valves used for slurry service typically have a resilient sealing insert around the outer perimeter of the valve body member to provide effective valve sealing. Pressure applied to a closed valve forces the resilient sealing insert to become a hydraulic seal and a portion of the insert is extruded into the gap between the valve body member and the valve seat member. For the insert to affect a hydraulic seal upon valve closure, the insert must protrude from the valve body member toward the valve seat member when the valve is open. The amount of protrusion of the insert is called the insert standoff. When the valve is nearly closed, the resilient sealing insert contacts the valve seat member before the contact surfaces of the valve body member and the valve seat member make contact. When the valve is closed, the resilient sealing insert is deformed against the seat member to form the hydraulic seal, and metal-to-metal contact occurs between the valve body member and the valve seat member in the strike face area. The insert material does not compress, but rather deforms. Repeated deformation of the insert material causes internal heat build-up and material stress within the insert material, and this can damage it. Combined with repeated deformation and presence of hard particles, such as sand or other proppant materials, extrusion and cyclic fatigue of the insert material can occur, and potential lead to further valve or pump damage and/or failure.

Also, conventional liquid end valve assemblies may also experience failures due to foreign objects becoming lodged within the valve assembly (e.g., bolts or gravel can accidentally enter the fluid flow path). These foreign objects can become wedged between the contact surfaces of the valve, and thus prevent the valve from closing, and damaging the sealing inserts. In an operational setting, continual inspection and maintenance efforts are made to detect damage to, and erosion of, the sealing inserts. However, making a decision to replace valves due to sealing insert damage and erosion can often be a subjective or difficult evaluation. This can often lead to unnecessary replacement and use of resources, or even damage to valves and/or pumps.

There is a need for improved valve assemblies which improve or overcome difficulties in assessing damage to, and erosion of, the sealing inserts, and such need is addressed, at least in part, by embodiments described in the following disclosure.

### SUMMARY

This section provides a general summary of the disclosure, and is not a necessarily a comprehensive disclosure of its full scope or all of its features.

In a first aspect of the disclosure, a valve element includes a valve body member formed of a rigid material, where the valve body member defines a front-to-rear extending longitudinal axis, and has a generally radially outwardly facing first contact surface of generally frusto-conical configuration tapering forwardly, and a radially inwardly extending annular recess disposed rearwardly of the contact surface. The valve body member further has a sealing insert mounted on the valve body member which includes a generally radially inwardly projecting lip received in the recess, an axially forwardly facing sealing face, a radially inwardly facing second contact surface disposed between the sealing face and the lip which tightly engages the first contact surface to conform to the frusto-conical configuration thereof, and a seal abrasion gauge disposed upon an outer peripheral portion of the axially forwardly facing sealing face. In some aspects, the seal abrasion gauge may be integrated with or otherwise disposed within the sealing insert. In some other aspects, the seal abrasion gauge is an insert disposed adjacent an outer peripheral portion of the axially forwardly facing sealing face and a radially outwardly facing third contact surface disposed upon an opposing side of the sealing insert relative the second contact surface. In some embodiments, the seal abrasion gauge has a color in contrast with a color of the sealing insert, and may be formed from a colorant infusion in the sealing insert.

In another embodiment of the disclosure, a valve element is provided which includes a valve body member formed of a rigid material, where the valve body member defines a front-to-rear extending longitudinal axis. The valve body member also has a generally radially outwardly facing first contact surface of generally frusto-conical configuration tapering forwardly, and a radially inwardly extending annular recess disposed rearwardly of the contact surface. The valve body member further has a sealing insert mounted on the valve body member which includes a generally radially inwardly projecting lip received in the recess, an axially forwardly facing sealing face, a radially inwardly facing second contact surface disposed between the sealing face and the lip which tightly engages the first contact surface to conform to the frusto-conical configuration thereof, and a seal abrasion gauge integrated with an outer peripheral portion of the axially forwardly facing sealing face. In some cases, the seal abrasion gauge is an insert disposed adjacent an outer peripheral portion of the axially forwardly facing sealing face and a radially outwardly facing third contact surface disposed upon an opposing side of the sealing insert relative the second contact surface, while in other cases the seal abrasion gauge is integrated with the sealing insert. The seal abrasion gauge may have a color in contrast with a color of the sealing insert.

Yet another aspect of the disclosure is a valve element having a valve body member formed of a rigid material, and the valve body member defines a front-to-rear extending longitudinal axis. The valve body member also has a generally radially outwardly facing first contact surface of generally frusto-conical configuration tapering forwardly, and a radially inwardly extending annular recess disposed rearwardly of the contact surface. The valve body member further includes a sealing insert mounted on the valve body member which includes a generally radially inwardly projecting lip received in the recess, an axially forwardly facing sealing face, a radially inwardly facing second contact surface disposed between the sealing face and the lip which tightly engages the first contact surface to conform to the frusto-conical configuration thereof, and a radially outwardly facing third contact surface disposed upon an opposing side of the sealing insert relative the second contact surface. A seal abrasion gauge is disposed adjacent the third contact surface.

### BRIEF DESCRIPTION OF THE DRAWINGS

Certain embodiments of the disclosure will hereafter be described with reference to the accompanying drawings, wherein like reference numerals denote like elements. It should be understood, however, that the accompanying figures illustrate the various implementations described and are not meant to limit the scope of various technologies described herein, and:

FIG. 1 illustrates a high pressure pump which includes valve elements, in a cross-sectional view;

FIG. 2 depicts a valve element showing erosion of sealing insert in accordance with the disclosure, and in a perspective view;

FIGS. 3A and 3B illustrates a valve element having an abrasion gauge in accordance with an aspect of the disclosure, in a cross-sectional view;

FIG. 4 depicts a valve element which includes another variation of a seal abrasion gauge in accordance with the disclosure, and in a cross-sectional view;

FIG. 5 illustrates another valve element in accordance with some aspects of the disclosure, and in a cross-sectional view; and,

FIG. 6 depicts yet another valve element according to an aspect of the disclosure, in a cross-sectional view.

### DETAILED DESCRIPTION

The following description of the variations is merely illustrative in nature and is in no way intended to limit the scope of the disclosure, its application, or uses. The description and examples are presented herein solely for the purpose of illustrating the various embodiments of the disclosure and should not be construed as a limitation to the scope and applicability of the disclosure.

Unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of concepts according to the disclosure. This description should be read to include one or at least one and the singular also includes the plural unless otherwise stated.

The terminology and phraseology used herein is for descriptive purposes and should not be construed as limiting in scope. Language such as “including,” “comprising,” “having,” “containing,” or “involving,” and variations thereof, is intended to be broad and encompass the subject matter listed thereafter, equivalents, and additional subject matter not recited.

Also, as used herein any references to “one embodiment” or “an embodiment” means that a particular element, feature, structure, or characteristic described in connection with the embodiment is included in at least one embodiment. The appearances of the phrase “in one embodiment” in various places in the specification are not necessarily referring to the same embodiment.

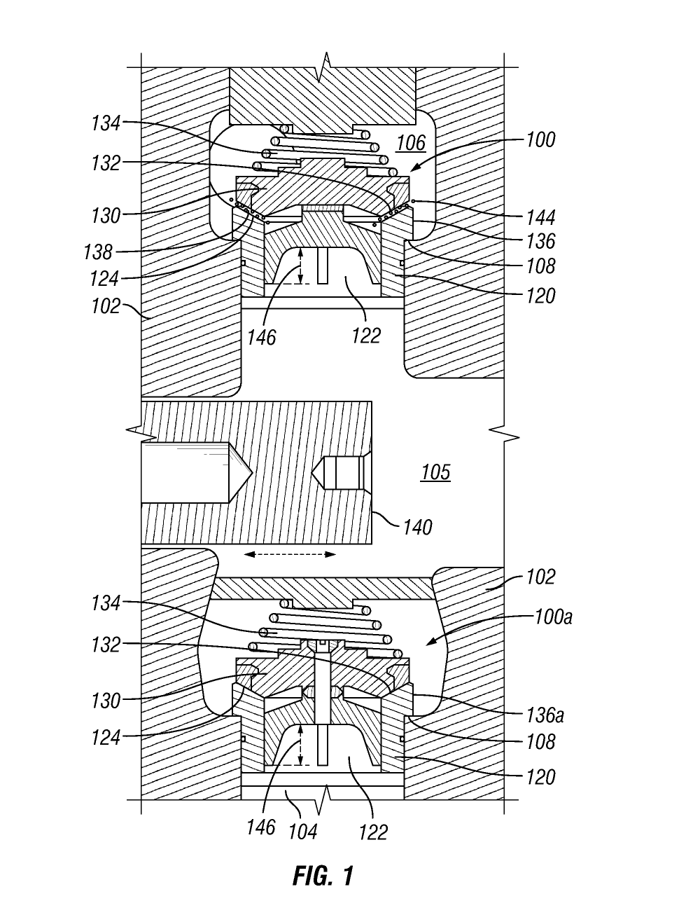

Referring to FIG. 1, a high pressure pump such as a plunger pump includes valve elements, shown generally as 100 (discharge valve) and 100a (suction valve). The valve elements 100 and 100a fit in the pump body 102, which forms a intake chamber 104, compression chamber 105, and a discharge chamber 106. Annular walls 108 in the pump body 102 provide structures for receiving valve seat members 120. Valve seat member 120 comprises a hollow bore 122 that provides a fluid flow path between the compression chamber 105 and the discharge chamber 106, or the compression chamber 105 and the intake chamber 104. Valve seat member 120 has a frusto-conical contact surface 124 and a generally cylindrical inner wall 126 that defines the valve seat member bore 122, and which can act as a guide surface. Valve body member 130 has a frusto-conical contact surface 132 that is complimentary to the frusto-conical contact surface 124 on the valve seat member 120. A compression spring 134 urges valve body member 130 toward the valve seat member 120 to create a contacting relationship between frusto-conical contact surface 124 and frusto-conical contact surface 132.

In operation, the discharge stroke of the plunger 140 results in an elevated pressure within the compression chamber 105. The elevated pressure within the compression chamber 105 causes the valve body member 130 of discharge valve 100 to move away from the valve seat member 120 as shown by the arrow 146. This allows fluid to be displaced from the compression chamber 105, through the valve seat member bore 122, and into the discharge chamber 106. Fluid flow from the compression chamber 105 into the discharge chamber 106 is referred to as forward flow through the valve apparatus 100. When valve body member 130 of discharge valve 100 is raised by fluid forces arising from the forward motion of the plunger 140, the compression spring 134 is compressed and exerts an increasing force downward on the valve body member 130. When the plunger 140 slows towards the end of its discharge stroke, the fluid forces upward on the valve body member 130 decrease and become less than the spring force downward on the valve body member 130. The valve body member 130 is pushed downwards towards its closed position against the valve seat member 120. The compression spring 134 moves the valve body member 130 towards the valve seat member 120 to reestablish the contacting relationship between frusto-conical contact surface 124 and frusto-conical contact surface 132. Further movement of the plunger 140 in a suction stroke will create a suction within the intake chamber 104 and the suction valve assembly 100a will work in a similar manner, allowing fluid to be drawn into the intake chamber 104 and compression chamber 105. At the start of the plunger 140 suction stroke, a small amount of fluid flows from the discharge chamber 106 into the suction chamber 104. This is referred to as reverse flow through the valve apparatus 100. This reverse flow will continue until the combined forces of the suction pressure within the intake chamber 104 and the compression spring 134 are sufficient to form a positive seal between the valve body member 130 and the valve seat member 120 of suction valve assembly 100a.

Forward flow and reverse flow through the valve apparatus 100 have separate working mechanisms and are not equivalent. Forward flow results when the pressure in the intake chamber 104 is sufficiently greater than the pressure in the discharge chamber 106 that it overcomes the resistance force applied by the compression springs 134. Forward flow involves hydrostatic pressure overcoming a resisting force. Reverse flow also needs a pressure differential across the valve assembly 100a. But rather than the pressure differential overcoming an opposing force, reverse flow involves the time lag inherent in the valve body member 130 of valve assembly 100a closing. Once the pressure has equalized between the intake chamber 104 and the discharge chamber 106, the forward flow of fluid will stop. At that time the valve body member 130 of valve assembly 100a will still be in the process of approaching the valve seat member 120, moving in response to the force from the compression spring 134. The time period between the cessation of the forward fluid flow and the closing of the valve body member 130 upon the valve seat member 120 is commonly referred to as valve lag. During this valve lag time period the start of the plunger suction stroke has reduced the pressure within the intake chamber 104 to less than the discharge chamber 106. This results in a reverse fluid flow until there is an adequate fluid seal between the valve body member 130 of valve assembly 100a and the valve seat member 120. If an adequate fluid seal between the valve body member 130 and the valve seat member 120 is not achieved, there will be reverse fluid flow throughout the entire suction stroke, and pumping efficiency may be significantly diminished.

A sealing insert 136 is attached to the valve body members 130 at the outer perimeter that acts to help effectuate a seal between frusto-conical contact surface 124 and frusto-conical contact surface 132. The distance between the sealing insert 136 and the opposing frusto-conical contact surface creates a valve exit gap 138. The sealing insert also acts to dampen the stress forces imposed on the valve seat member 120 and the valve body member 130 upon valve closure. For the sealing insert 136 to be effective, the valve exit gap 138 between the sealing insert 136 and the valve seat contact surface 124 must be smaller than the gap between the valve body member contact surface 132 and the valve seat contact surface 124, when the valve is open.

A common problem often occurs within pump assemblies that are used to pump solid laden fluids or slurries, such as hydraulic fracturing fluid containing proppant particles. As the valve body member 130 approaches the valve seat member 120, the resilient insert 136 approaches the opposing frusto-conical contact surface 124 and the valve exit gap 138 decreases. When the valve exit gap 138 reaches a certain point (for example, about 1.0-2.5 times the average solid particle diameter), the valve exit gap 138 will act to screen out the solid particles while still allowing fluid flow to pass. This forward screening effect will result in an accumulation of solid particles 144 (sixteen shown) between the valve seat member 120 and the valve body member 130. As the valve body member 130 closes against the valve seat member 120, the accumulation of solid particles 144 imposes localized forces onto the valve assembly. These localized forces can result in damage to the valve seat member 120, the valve body member 130 or the resilient insert 136, such as pitting or erosion on one or more of the frusto-conical contacting surfaces or resilient insert. Hence, in an operational setting, continual inspection and maintenance efforts are thus required to detect damage to, deformation of, and erosion of, the resilient sealing inserts 136. In some cases where sealing inserts 136 significantly erode or fail, crushing of individual particles may result in Hertzian contact stresses and damage to the frusto-conical contact surfaces 124 and/or 132.

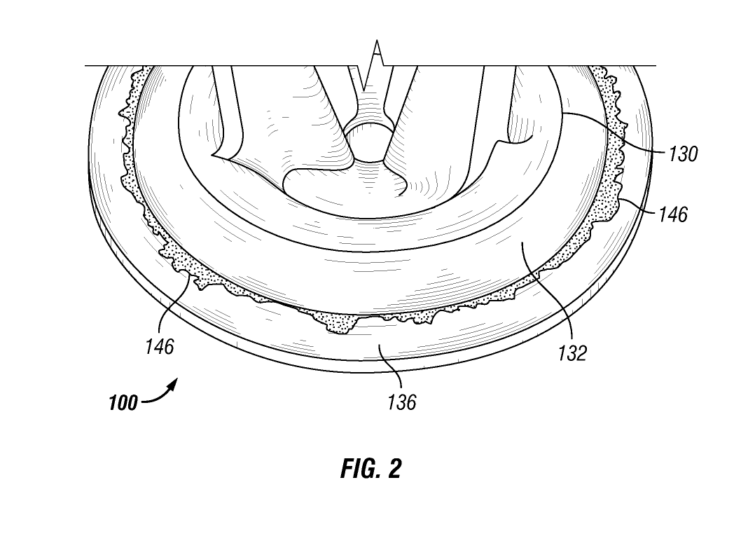

FIG. 2 illustrates valve element 100 in a perspective view, and inverted orientation, showing erosion of sealing insert 136. As illustrated, valve element 100 includes sealing insert 136 disposed on the periphery of valve body member 130, and includes an axially forwardly facing sealing face. Sealing insert 136 is seated adjacent frusto-conical contact surface 132. As described above, when valve body member 130 closes against a valve seat member, the accumulation and contact of solid particles can result in damage to the axially forwardly facing sealing face of sealing insert 136. Such damage is shown as erosion 146 occurring in the portion of sealing insert 136 adjacent frusto-conical contact surface 132.

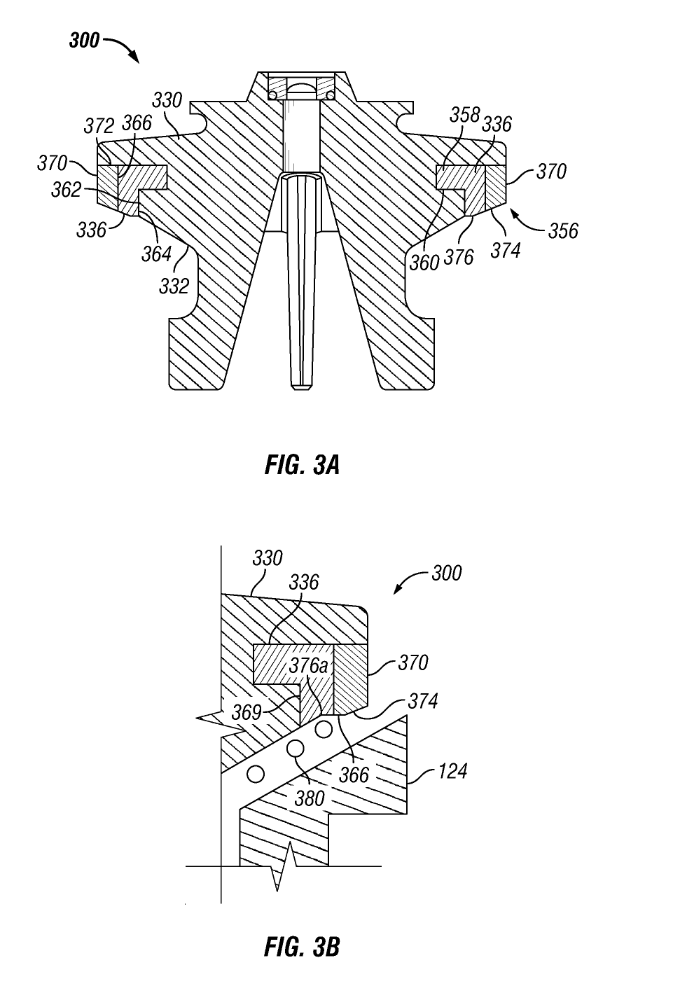

Now referring to FIG. 3A, which illustrates valve element 300 in a cross-sectional view. The valve element 300 may generally fit in a pump body, such as pump body 102 of FIG. 1 forming an intake or pressure chamber 104, compression chamber 105, and/or discharge chamber 106, and which includes valve seat member 120. Valve element 300 further includes valve body member 330 and sealing insert 336 disposed on the valve body member 330, which helps effectuate a seal between frusto-conical contact surface 332 and a frusto-conical contact surface of a valve seat member, such as valve seat members 124 in FIG. 1. Valve body member 330 may be formed of a rigid material, such as metal. Sealing insert 336 is mounted on valve body member 330 in the form of an annular ring-shaped insert formed of an elastomeric material such as urethane or rubber, or any other sealingly resilient material, for example. In some cases, the sealing insert 336 is mounted onto the valve body member 330 by being stretched and slid axially over the front end of the body (i.e., over the lower end thereof as viewed in FIG. 3A) before being released to snap into an annular groove 356 of valve body member 330. In that fashion, a radially inwardly projecting annular lip 358 of the sealing insert 336 enters a radially inwardly recessed annular portion 360 of the groove 356, and an inner contact surface 362 of sealing insert 336 tightly engages an outer contact surface 364 of valve body member 330. In other aspects, the sealing insert 336 can be manufactured in place on the valve body member 330.

Sealing insert 336 further includes a peripheral contact surface 366, and axially forwardly facing sealing face 376. In some aspects of the disclosure, sealing insert 336, or any sealing insert according to the disclosure, is formed of a material and/or contains additives with anti-extrusion properties to reduce or even prevent sealing insert material extrusion into the gap, such as exit gap 138 shown in FIG. 1. A seal abrasion gauge 370 disposed adjacent to and tightly engages the contact surface 366 of sealing insert 336. Seal abrasion gauge 370 is also disposed within annular groove 356, and is tightly engaged with contact surface 372 of valve body member 330. Similar to sealing insert 336, seal abrasion gauge 370 is mounted on valve body member 330 in the form of an annular ring-shaped insert. Seal abrasion gauge 370 includes a frusto-conical shaped contact surface 374 which may further effectuate a seal between frusto-conical contact surface 332 and a frusto-conical contact surface of a valve seat member.

Now referencing FIG. 3B, in operation when valve body member 330 closes against a valve seat member (such as seat member 124), accumulation of, and/or contact with, solid particles 380 laden in pumped fluid occurs, which in turn damages the axially forwardly facing sealing face 376a of sealing insert 336. Over a period of use, erosion to the sealing face 376a of sealing insert 336 gradually migrates in an outward path, beginning at a lower edge of contact surface 364 and continuing to a lower edge of peripheral contact surface 366 of sealing insert 336. Once the erosion has reached the lower edge of inner contact surface 366 of seal abrasion gauge 370, it may become readily observable that valve element 300 may need replacement, repair, or maintenance. In some aspects, the observable indication may be presented visually, color, by raised ridge, or contour difference between surface 374 and eroded surface 376a, or combination thereof. In some aspects where an indication of sealing face 376a erosion is detected visually, sealing insert 336 may have a first color, while seal abrasion gauge 370 has a second color in at least adequate contrast with the first color, such that an observer may visually ascertain erosion has reached the lower edge of inner contact surface 366. In yet other aspects where a visual indication of sealing face 376a erosion is used, a difference in contour or surface shape between surface 374 and eroded surface 376a is observable. In some other instances, the difference in contour or surface shape between surface 374 and eroded surface 376a may be detected by touch.

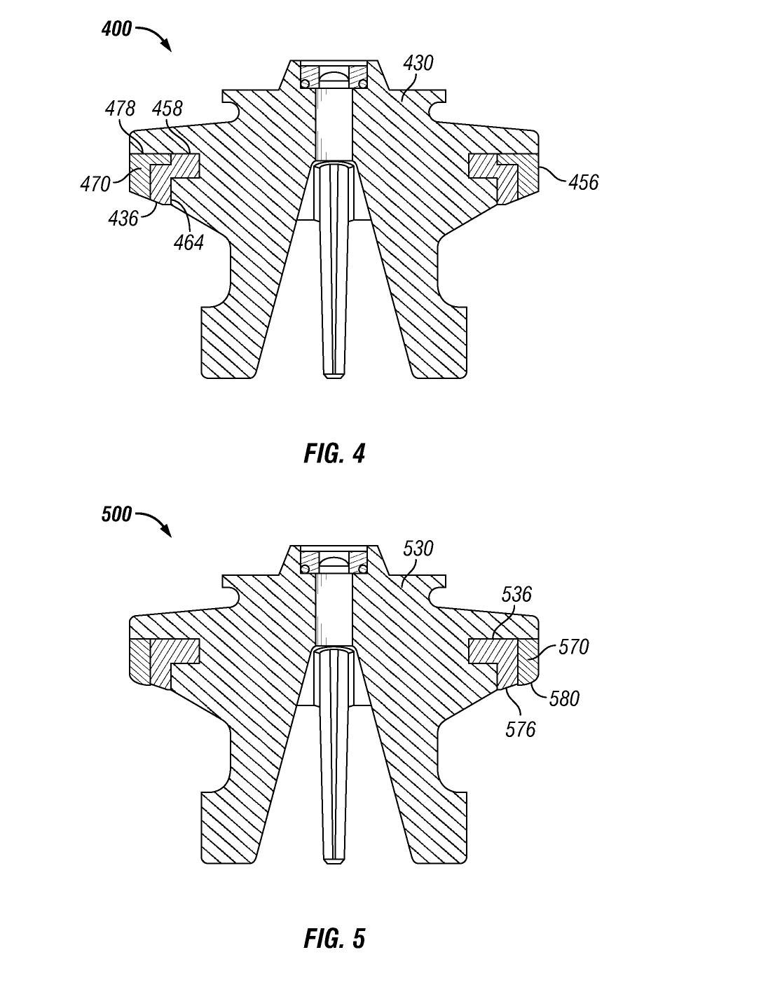

FIG. 4 illustrates valve element 400 in a cross-sectional view, which includes another variation of a seal abrasion gauge, in accordance with some other embodiments of the disclosure. The valve element 400 includes valve body member 430 and sealing insert 436 disposed on the valve body member 430. Seal abrasion gauge 470 is disposed outwardly adjacent sealing insert 436. Sealing insert 436 and seal abrasion gauge 470 are mounted on valve body member 430 in the form of annular ring-shaped structures, and may be preassembled prior to mounting on valve body member 430. The sealing insert 436 and seal abrasion gauge 470 are mounted onto the valve body member 430 by being stretched and slid axially over the front end of the valve body member 430 before being released to snap into an annular groove 456 of valve body member 430. Both of the insert 436 and gauge 470 are secured within groove 456 in similar fashion as described above for FIG. 3, where sealing insert 436 tightly engages an outer contact surface 464 of valve body member 430. Seal abrasion gauge 470 further includes inwardly projecting annular lip 478 in tight contact with valve body member 430, and inwardly projecting annular lip 458 of sealing insert 436.

FIG. 5 depicts another valve element in a cross-sectional view in accordance with yet other embodiments of the disclosure. Valve element 500 is similar to valve element 300 shown in FIG. 3 and further includes a raised feature disposed on contact surface 580 of seal abrasion gauge 570. Seal abrasion gauge 570 is disposed outwardly adjacent sealing insert 536, both of which securely in contact with valve body member 530. The raised feature extends above a plane upon which axially forwardly facing sealing face 576 of sealing insert 536 falls. The extent of erosion of sealing face 576 may be detected and evaluated by reference to the raised feature on surface 580. The raised feature may be a continuous ring formed around the circumference of surface 580 in some cases, while in other aspects, the raised feature may be intermittently disposed thereon, such as a bump, nib, partial ridge, and the like. In some cases, the raised feature is wearable.

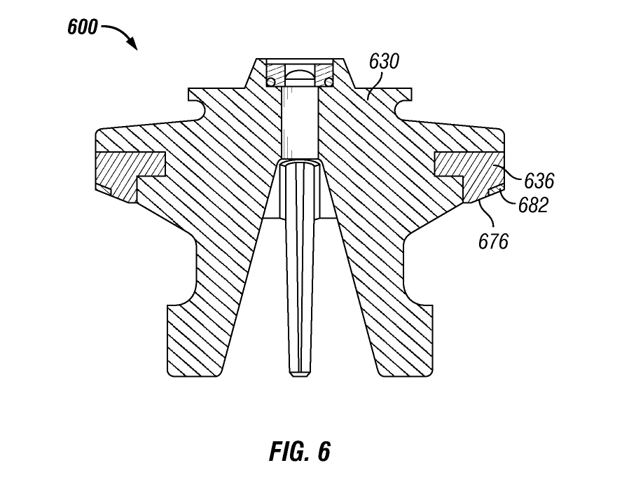

Another embodiment of a valve element in accordance with the disclosure is shown in FIG. 6, in a cross-sectional view. Valve element 600 includes sealing insert 636 with seal abrasion gauge 682 disposed upon an outer peripheral portion of the axially forwardly facing sealing face 676. Seal abrasion gauge 682 may be formed material different than the material forming sealing insert 636, and fused within the sealing insert 636. In some other aspects, seal abrasion gauge 682 may be a colorant infused into the sealing insert 636, having a color with adequate visual contrast with the color of sealing insert 636.

The components of the valve elements in accordance with the disclosure may be made from a variety of materials depending on design factors such as the type of fluid to be pumped and the pressure rating that is needed. For example, the pump body portion 102 and the valve seat member 120, shown in FIG. 1, may be made of metal. The valve body members also, may be made of metal but could also be made from composites or other durable materials in an effort to control the weight and balance of the valve body members. The frusto-conical contact surfaces, such as 124 and 132, are typically made from a durable metal, while the sealing inserts are usually made from an elastomeric deformable material such as polyurethane, or any suitable thermoset or thermoplastic elastomer, such as, but not necessarily limited to, natural polyisoprene, synthetic polyisoprene, polybutadiene, chloropene, butyl rubber, halogenated butyl rubbers styrene-butadiene rubber, nitrile rubber, hydrogenated nitrile rubber, ethylene propylene rubber, epichlorohydrin rubber, polyacrylic rubber, silicone rubber, fluorosilicone rubber, fluoroelastomers, perfluoroelastomers, polyether block amides, chlorosulfonated polyethylene, ethylene-vinyl acetate, polyaryletherketone, polyetheretherketone, combinations thereof, and the like. This material may be selected based upon properties of elasticity and capability for surviving large repeated deformations and/or impacts. In some aspects, such materials are softer and more pliable elastomers. In some other aspects, two or more different elastomeric materials (e.g., two different polyurethanes with appropriate properties) make up the sealing insert.

Materials used to form seal abrasion gauge according to the disclosure may in some cases be like materials as those used to form the sealing inserts, and in some other instances, materials different from those used to form the sealing inserts. When different materials are used, they are generally more abrasion or wear resistant than the sealing insert material. Such material may be selected based upon properties of abrasion resistance and capability for surviving large repeated deformations, and may include materials such as polyurethane, polyamide, polyacetal, polytetrafluorethylene, epoxies, polyimide, polycarbonate, polyethylene, polypropylene, polydimethylsiloxane, or any suitable thermoset or thermoplastic polymers, combinations thereof, and the like. In some aspects, the material may be further amended with other components to achieve targeted properties, such as aramid fiber, carbon fiber, graphite powder, glass fiber, molybdenum disulfide particles, and the like.

The foregoing description of the embodiments has been provided for purposes of illustration and description. Example embodiments are provided so that this disclosure will be sufficiently thorough, and will convey the scope to those who are skilled in the art. Numerous specific details are set forth such as examples of specific components, devices, and methods, to provide a thorough understanding of embodiments of the disclosure, but are not intended to be exhaustive or to limit the disclosure. It will be appreciated that it is within the scope of the disclosure that individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Also, in some example embodiments, well-known processes, well-known device structures, and well-known technologies are not described in detail. Further, it will be readily apparent to those of skill in the art that in the design, manufacture, and operation of apparatus to achieve that described in the disclosure, variations in apparatus design, construction, condition, erosion of components, gaps between components may present, for example.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

Although a few embodiments of the disclosure have been described in detail above, those of ordinary skill in the art will readily appreciate that many modifications are possible without materially departing from the teachings of this disclosure. Accordingly, such modifications are intended to be included within the scope of this disclosure as defined in the claims.

What is claimed is:

1. A valve element comprising:
a valve body member formed of a rigid material, the valve body member defining a front-to-rear extending longitudinal axis and including:
a generally radially outwardly facing first contact surface of generally frusto-conical configuration tapering forwardly;
a radially inwardly extending annular recess disposed rearwardly of the contact surface; and,
a sealing insert mounted on the valve body member, the sealing insert comprising:
a generally radially inwardly projecting lip received in the recess;
an axially forwardly facing sealing face;
a radially inwardly facing second contact surface disposed between the sealing face and the lip and tightly engaging the first contact surface to conform to the frusto-conical configuration thereof; and,
a seal abrasion gauge disposed upon an outer peripheral portion of the axially forwardly facing sealing face.

2. The valve element of claim 1 wherein the seal abrasion gauge is integrated with the sealing insert.

3. The valve element of claim 1 wherein the seal abrasion gauge is an insert disposed adjacent an outer peripheral portion of the axially forwardly facing sealing face and a radially outwardly facing third contact surface disposed upon an opposing side of the sealing insert relative the second contact surface.

4. The valve element of claim 3 wherein the seal abrasion gauge is an insert ring.

5. The valve element of claim 1 wherein the seal abrasion gauge has a color in contrast with a color of the sealing insert.

6. The valve element of claim 5 wherein the color is formed from a colorant infusion in the sealing insert.

7. The valve element of claim 1 wherein the seal abrasion gauge further comprises forwardly facing wearable protrusions.

8. The valve element of claim 1 wherein the sealing insert comprises anti-extrusion properties.

9. A valve element comprising:
a valve body member formed of a rigid material, the valve body member defining a front-to-rear extending longitudinal axis and including:
a generally radially outwardly facing first contact surface of generally frusto-conical configuration tapering forwardly;
a radially inwardly extending annular recess disposed rearwardly of the contact surface; and,
a sealing insert mounted on the valve body member, the sealing insert comprising:
a generally radially inwardly projecting lip received in the recess;
an axially forwardly facing sealing face;
a radially inwardly facing second contact surface disposed between the sealing face and the lip and tightly engaging the first contact surface to conform to the frusto-conical configuration thereof; and,
a seal abrasion gauge integrated with an outer peripheral portion of the axially forwardly facing sealing face.

10. The valve element of claim 9 wherein the seal abrasion gauge is an insert disposed adjacent an outer peripheral portion of the axially forwardly facing sealing face and a radially outwardly facing third contact surface disposed upon an opposing side of the sealing insert relative the second contact surface.

11. The valve element of claim 10 wherein the seal abrasion gauge is an insert ring.

12. The valve element of claim 9 wherein the seal abrasion gauge is integrated with the sealing insert.

13. The valve element of claim 9 wherein the seal abrasion gauge has a color in contrast with a color of the sealing insert.

14. The valve element of claim 13 wherein the color is formed from a colorant infusion in the sealing insert.

15. The valve element of claim 9 wherein the seal abrasion gauge further comprises forwardly facing wearable protrusions.

16. The valve element of claim 9 wherein the sealing insert comprises anti-extrusion properties.

17. A valve element comprising:
a valve body member formed of a rigid material, the valve body member defining a front-to-rear extending longitudinal axis and including:
a generally radially outwardly facing first contact surface of generally frusto-conical configuration tapering forwardly;
a radially inwardly extending annular recess disposed rearwardly of the contact surface;
a sealing insert mounted on the valve body member, the sealing insert comprising:
a generally radially inwardly projecting lip received in the recess;
an axially forwardly facing sealing face;
a radially inwardly facing second contact surface disposed between the sealing face and the lip and tightly engaging the first contact surface to conform to the frusto-conical configuration thereof;
a radially outwardly facing third contact surface disposed upon an opposing side of the sealing insert relative the second contact surface; and,
a seal abrasion gauge disposed adjacent the third contact surface.

18. The valve element of claim 17 wherein the seal abrasion gauge is integrated with the sealing insert.

19. The valve element of claim 17 wherein the seal abrasion gauge is an insert disposed adjacent an outer peripheral portion of the axially forwardly facing sealing face and third contact surface.

20. The valve element of claim 19 wherein the seal abrasion gauge is an insert ring.

21. The valve element of claim 17 wherein the seal abrasion gauge has a color in contrast with a color of the sealing insert.

22. The valve element of claim 17 wherein the seal abrasion gauge further comprises forwardly facing wearable protrusions.

23. The valve element of claim 17 wherein the sealing insert comprises anti-extrusion properties.
